(19) United States
(12) Patent Application Publication
(10) Pub. No.: US 2008/0143517 A1
(43) Pub. Date: Jun. 19, 2008

(54) Method and Apparatus to Alert the Hearing Impaired of Events Such as Incoming Telephone Calls

(75) Inventor: Glen P. Goffin, Dublin, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,872

(22) Filed: Dec. 14, 2006

(51) Int. Cl. G08B 21/00; H04M 3/42

(52) U.S. Cl. 340/540; 379/207.02

(57) ABSTRACT

A method and apparatus is provided to alert a user of the occurrence of an event such as an incoming telephone call, e-mail, emergency alarm, scheduled appointment reminder, and the like, through the generation of an alert or control signal. An electronic device having networking capabilities, such as an IP-based (Internet Protocol) videophone, is arranged to transmit the alert trigger or control signal to another networked device like a home monitoring or home automation device. In an illustrative example, a videophone detects an incoming call and sends an alert trigger or control signal to a home lighting controller. The alert trigger or control signal instructs the home lighting controller to turn lights on and off in the home in a “ringing” pattern to indicate the incoming call.

### BACKGROUND

Videophones are tremendously important to the hearing impaired community because they enable the use of non-verbal communication techniques like signing. In particular, sign language is “spoken” with the hands, and is very different from English in how information, thoughts, and ideas are expressed. Deaf and hearing-impaired parties using videophones are thus able to effectively express themselves with emotions and other subtleties using sign language which they cannot do through the use of assistive traditional telephony equipment such as teletype terminals.

Unfortunately, a problem can occur when a call comes in and a deaf or hearing impaired user is not near the videophone to see a visual ringing indicator. As a result, it would be beneficial if some additional ways of being alerted to the incoming phone call were available.

### DESCRIPTION OF THE DRAWINGS

FIG. 1 is a diagram of an illustrative videophone that is in operative communication with a variety of devices over a home network;

FIG. 2 is a block diagram of an illustrative arrangement for generating an alert trigger responsively to an event such as a telephone call;

FIG. 3 is a block diagram of an illustrative arrangement for generating a control signal that is utilized to control a networked device responsively to an event such as a telephone call;

FIG. 4 is a flowchart of an illustrative method for generating an alert trigger and control signal, in response to a detected event, that are transmitted to a networked device which thereby renders an alert or invokes a responsive action; and

FIG. 5 is a flowchart of an illustrative method performed by one or more networked devices responsively to an alert trigger or a control signal.

### DETAILED DESCRIPTION

A method and apparatus are provided to alert a user of the occurrence of an event such as an incoming telephone call, e-mail, emergency alarm, scheduled appointment reminder, and the like, through the generation of an alert trigger or control signal. An electronic device having networking capabilities, such as an IP (Internet Protocol)-based videophone, is arranged to transmit the alert trigger or control signal to another networked device like a home monitoring or home automation device. In an illustrative example, a videophone detects an incoming call and sends an alert trigger or control signal to a home lighting controller. The alert trigger or control signal instructs the home lighting controller to turn lights on and off in the home in a “ringing” pattern to indicate the incoming call.

In other illustrative examples, the electronic device discovers networked devices on a home network that have alert rendering capability or are controllable. Upon the detection of the occurrence of an event, the electronic device uses a messaging or communication protocol to invoke responsive actions by the networked devices. For example, the networked devices generate audio announcements, play music, render video, etc. responsively to the alert trigger or control signal to thereby signal that the event has occurred.

The alerts are also personalizable according to user input so that each alert is unique. The alerts are thus optionally tailored to the characteristics of individual users in the home. For example, when an e-mail comes in at a personal computer (“PC”) for a hearing-impaired resident in the home, the lights are flashed by the home lighting controller. When an e-mail comes in for a visually-impaired resident, a networked device, such as an IP radio plays an announcement or music.

The electronic device is also arrangeable as a “proxy” device for non-networked devices such as regular telephones (e.g., telephones coupled to the public switched telephone network or “PSTN”) or mobile phones. For example, a videophone detects the ringing of a PSTN telephone or mobile phone and then sends an alert trigger to a PC which then renders an alert message on an attached monitor.

The method and arrangement described herein advantageously enables alerts to be extended throughout the home using networked devices to signal events such as a telephone ringing. The personalization feature affords greater flexibility in the types of alerts that are rendered, to whom, in which location, and the information imparted by the alerts. In addition, the present method and arrangement provides an important achievement in assistive technology that is usable by sense-impaired persons.

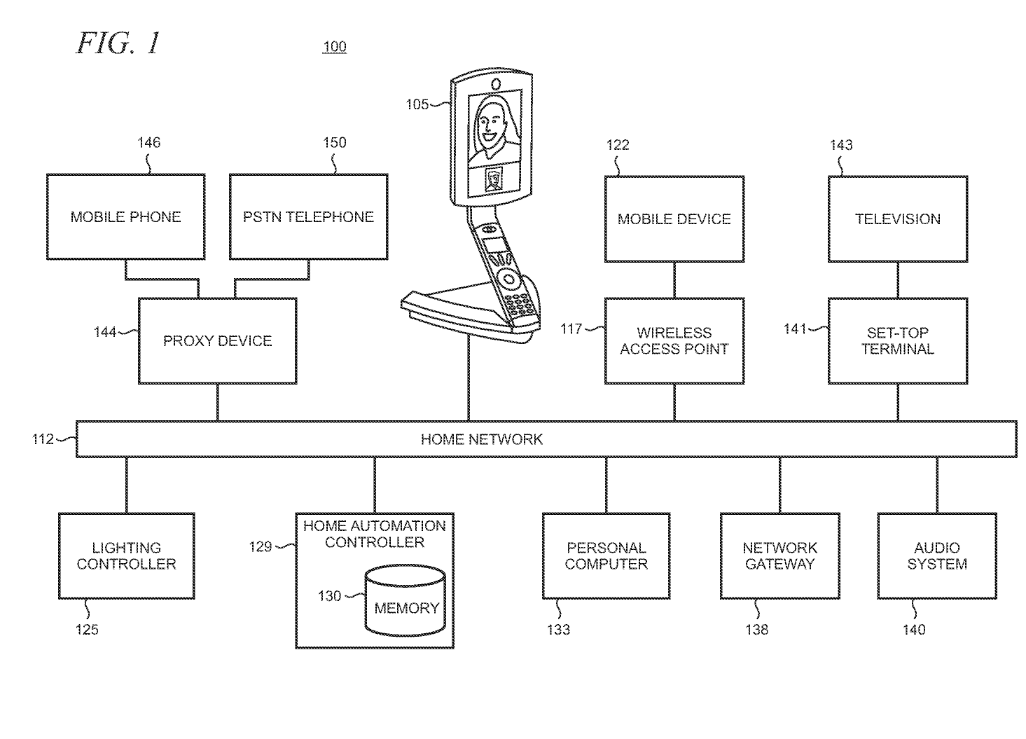

Turning now to FIG. 1, a diagram is provided of an illustrative arrangement 100 in which a videophone 105 is in operative communication with a variety of devices over a home network 112. Videophone 105 is arranged, in this illustrative example, as an IP-based phone that sends and receives video images and sounds using the IP protocol. Videophone 105 thus includes networking capability with other devices that are coupled to the home network 112.

Home network 112 is typically implemented with an Ethernet-type network using IP addressing. Home network 112 is often arranged to include wireless capability using one or more wireless access points, such as access point 117, that communicate with one or more mobile devices, such as mobile device 122. Such wireless communications is achievable in accordance with IEEE 802.11x (Institute of Electrical and Electronics Engineers where “x” is used to designate any of the variety of protocols including 802.11(a), 802.11(b), 802.11(g) and 802.11(n)). Other various wireless communication protocols are also utilizable including BlueTooth, ZigBee, and infrared (“IR”) arrangements, for example. Various networking types, protocols and arrangements are alternatively used to implement home network 112 depending upon the requirements of a specific application of event alerting. The arrangements include, for example, coaxial cable networking, MoCA (Multimedia over Coax Alliance) networking, HomePlug networking, HPNA (Home Phoneline Networking Alliance) networking, powerline networking, optical networking, or telephone networking.

Mobile device 122 is representative of portable wireless devices including mobile phones, handheld game players, personal digital assistants (“PDAs”), pocket PCs, smartphones, media or music players (such as MP3 players using MPEG Audio Layer III under the International Standards Organization Moving Pictures Expert Group) and other similarly configured devices.

A variety of illustrative networked devices are also shown in FIG. 1 as being connected to home network 112. Included are a lighting controller 125, home automation controller 129, PC 133, network gateway 138, audio system 140 (e.g., home entertainment or stereo system), and a set-top terminal 141 (with a coupled television 143). Some or all of these devices are commonly found in automated homes. The term “automated home” as used herein means a home that taps into the various household networks, such as home network 112, to provide useful services through central monitoring and control of the connected devices. Home automation promises greater convenience, time savings, and personal security and comfort for users. Automated homes are sometimes referred to as “intelligent homes” or “smart homes.”

A few examples of services enabled by home automation technology include: a home entertainment system playing a person's favorite music and responding to their voice commands; lighting and heating/ventilation/air conditioning (“HVAC”) automatically adjusting depending on time of day and whether anyone is currently at home; kitchen appliances such as the oven and coffee maker activating in advance of a person waking up in the morning or returning home; and a home PC automatically sending e-mail to the office, or the telephone system calling a mobile phone number should a home emergency (such as a water leak or power failure) occur.

Lighting controller 125 is arranged, in this illustrative example, to control home lighting (e.g., room and/or exterior lighting) in one or more locations in the home. Lighting controller 125 includes programming logic and is typically programmable by a user through a directly connected user interface (not shown) or via a PC such as PC 133, over a network connection. The user is commonly provided with options to turn selected lights on and off at various times in various locations.

Home automation controller 129 is arranged to include similar features and functionalities as lighting controller, but in an expanded fashion to include control over more devices in the home beyond lighting. For example, home automation controller 129 is often used to enable programmable user control over HVAC systems, appliances, home security systems, lighting, home entertainment systems and other devices in the home. In this illustrative example, home automation controller 129 includes a memory 130 that is commonly utilized, for example, to store user preferences/profiles, applications, and other data. Note that in most home automation environments, lighting controller 125 and home automation controller 129 are alternatively utilized. That is, most homes will use one or the other, but normally not both.

PC 133 is arranged to include functionalities for rendering alerts as described herein. Typically, PC 133 is provided with a software application that listens for alert triggers or control signals from videophone 105. When an alert trigger or control signal is received, the application invokes a method to responsively render an alert or perform a programmed action. For example, PC 133 is arrangeable to play a sound or announcement, flash a static or video message on its screen, or generate some other desired alert or invoke a desired responsive action.

In a similar manner as with PC 133, a mobile device 122 is provided with functionality that is utilizable to render an alert or perform an action responsively to an alert trigger or control signal received from videophone 105. For example, a user playing a game on a handheld game player is provided with an animation that plays on the player's screen when the user receives an instant message (“IM”) from a friend on the user's PC or mobile phone. Another animation is played when a friend logs on to an IM service. Other alerts are renderable, for example, when messages are received via the short message service (“SMS”) or multimedia messaging service (“MMS”).

Network gateway 138 provides a connection from external networks to devices on home network 112 such as online content and resources on wide area networks like the Internet.

Set-top terminal 141 is commonly utilized to receive multimedia content including television programming, movies, music, and other content, typically on a subscription basis. Other media content is often available using the set-top terminal 141 on a single event basis through video-on-demand and pay-per-view services. Set-top terminal 141 is normally coupled to a high bandwidth multimedia network such as a cable television or satellite network (not shown).

A proxy device 144 is coupled to home network 112. Proxy device 144 is further coupled to non-networked devices which, in this illustrative example, include a mobile phone 146 and a PSTN telephone 150. The proxy device 144 provides mobile phone 146 and PSTN telephone 150 with the capability to trigger alerts at remote devices by proxy through the connection to home network 112. Proxy device 144 is thus arranged to detect an event, such as the ringing of the mobile phone 146 or PSTN telephone 150, and then generate an alert trigger or control signal that is transmitted over home network 112 to be rendered by one of the networked devices. For example, when mobile phone 146 rings, proxy device 144 sends an alert trigger to lighting controller 125 which flashes the lights in the room to signal the ringing to a hearing-impaired user.

The detection feature implemented in proxy device 144 is alternatively implemented using a sensor such as a microphone or via a hardwire connection to the non-networked devices' external data port or ringer, for example. It is also noted that such proxy functionalities and features of proxy device 144 are beneficially incorporated, in some applications of event alerting, into other devices. For example, videophone 105 may be thus equipped so it can be used to create an alert trigger or control signal to networked devices on home network 112 by proxy for either mobile phone 146 or PSTN telephone 150.

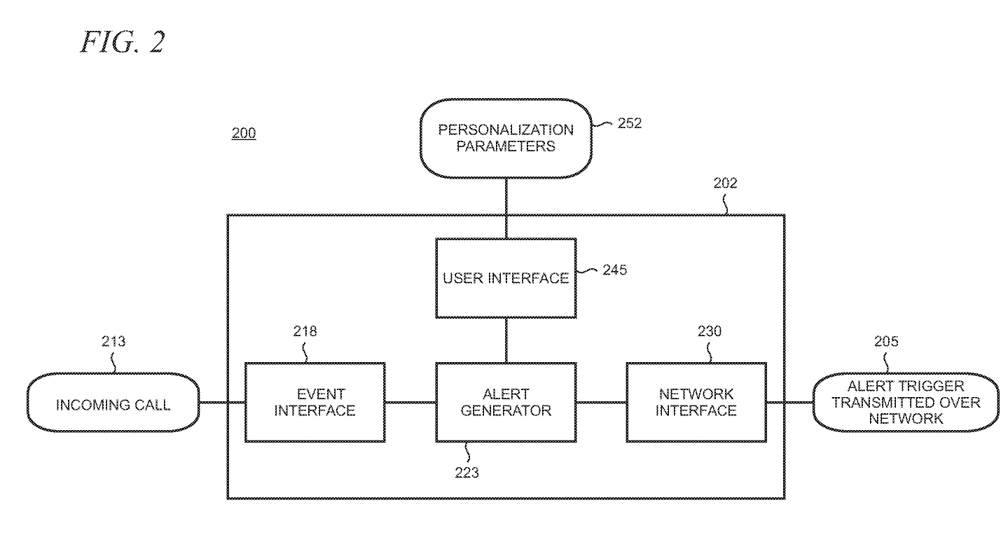

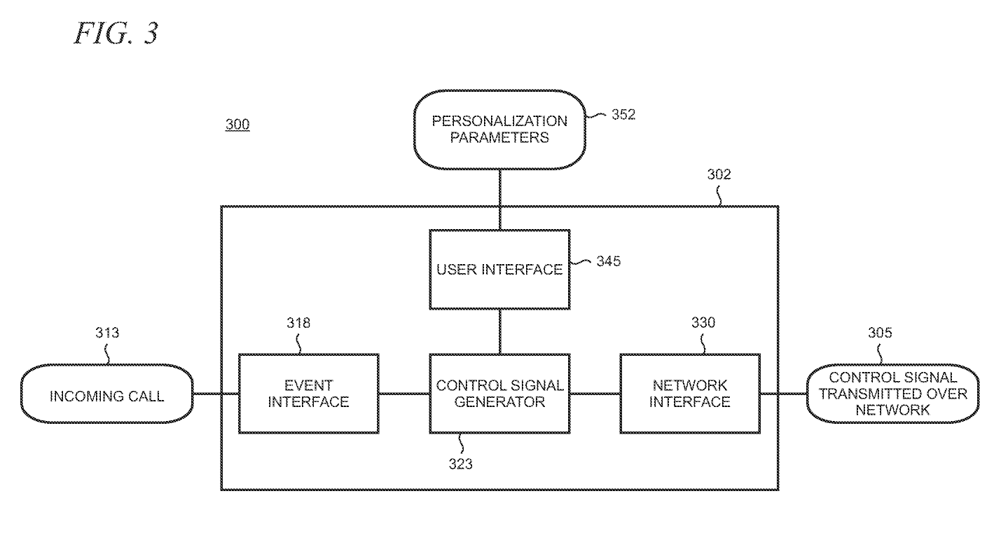

FIG. 2 is a block diagram of an illustrative arrangement 200 in which an electronic device 202 such as a videophone (e.g., videophone 105 in FIG. 1) is arranged to generate an alert trigger 205 responsively to an event such as an incoming telephone call 213. The alert trigger 205 is typically arranged as a short message that is sent from the electronic device 202 over a network (e.g., home network 112 in FIG. 1) to other networked devices on the network. For example, alert trigger 205 may be implemented using a simple binary signal (e.g., high-low voltage signal) or other short message signal type. That is, alert trigger 205 is utilized to convey that a change of state or status has occurred at the electronic device 202 but not necessarily include information beyond that (compare to the “control signal” described in text accompany FIG. 3). The message is alternatively implemented using one of a variety of conventional protocols including IP, SOAP (Simple Object Access Protocol), CIS (COM Internet Services, DCOM (Distributed Component Object Model), HTTP (Hypertext Transfer Protocol) using, for example XML (eXtensible Markup Language) or XHTML (eXtensible Hypertext Markup Language), RDS (Remote Data Services), SIP (Session Initiation Protocol), SIMPLE (Session Initiation Protocol for Instant Messaging and Presence Leveraging Extensions), UPnP (Universal Plug and Play), or XML-RPC (eXtensible Markup Language Remote Procedure Call), for example.

It is contemplated that alert trigger 205 is a relatively short message as it merely needs to inform the receiving networked device that an event of interest has occurred. The action invoked at the receiving networked device, or the rendering of the alert, is determined by programming that is contained within the receiving networked device. Thus, for example, a particular pattern of light flashing is determined by a lighting controller (e.g., lighting controller 125 in FIG. 1) responsively to user programming that is input to the lighting controller.

Electronic device 202 includes an event interface 218 that is arranged to detect the occurrence of an event. Although an incoming call 213 is shown in the illustrative example of FIG. 2, any of a wide variety of common events that may occur in a home is contemplated as being detectable. These include, merely by way of example but not as a limitation: incoming phone call, incoming video telephone call, incoming e-mail, incoming video message, door bell activation, door knock, change in status of an IM messaging list (often termed a “buddy list”), emergency alarm, fire alarm, smoke detector alarm, carbon monoxide alarm, burglar alarm, water level alarm, home monitoring status signaling, motion sensor alarm, appointment reminder, schedule reminder, instant message, message from an SMS service, or message from an MMS service.

Such detection is accomplished, for example, by receiving a detection signal from an appropriate sensor. For example, a home automation controller (e.g., home automation controller 129 in FIG. 1) monitors a variety of sensors distributed throughout an automated home to detect the occurrence of events such as movement within the house, lighting being turned on and off, alarm activation and the like. Alternatively, in the case of electronic messages and phone calls, the receiving device like a PC or IP-based videophone directly detects the event when the message or call is received as an electronic signal at an appropriate input port. Thus, event interface 218 is alternatively arranged as an input port for an indirectly-detected signal or a directly-received signal.

The event interface 218 is operatively coupled to an alert trigger generator 223 which generates the alert trigger 205 responsively to the detected event. Alert trigger generator 223 transmits the alert trigger 205 over a network interface 230 to a remote networked device. Network interface 230 is commonly arranged as a TCP/IP (Transmission Control Protocol/Internet Protocol) interface to enable a wide variety of communication protocols to be utilized and message types to be sent and received over the network.

The alert trigger generator 223 is further coupled to a user interface 245, as shown in FIG. 2. User interface 245 is arranged to enable a user to set personalization parameters 252 that are applied to the generation of the alert trigger 205. Personalization parameters 252 enable the user to select and/or adjust how the electronic device sends the alert trigger 205. In particular, the personalization parameters enable tailoring of the alert to an individual's characteristics or preferences.

For example, the user-generated personalization parameters 252 are alternatively arranged to select which remote networked device renders the alert, or what kind of event triggers a particular alert. For example, a hearing-impaired user may wish to have the alert trigger 205 sent by the electronic device 202 to a lighting controller to flash lights on and off upon the receipt of an incoming phone call.

In another example, the user-generated personalization parameters 252 tell the alert trigger generator 223 to send the alert trigger 205 to a PC (such as PC 133 in FIG. 1) when the detected event is a call that is received on a mobile phone owned by a user named John. The alert trigger 205 is sent to a handheld game device when the detected event is an email that is received and addressed to a user named Peter.

FIG. 3 is a block diagram of an illustrative arrangement 300 in which an electronic device 302, such as a videophone (e.g., videophone 105 in FIG. 1), is arranged to generate a control signal 305 responsively to an event such as an incoming telephone call 313. As noted above, incoming telephone call 313 is merely illustrative as other types of detected events are contemplated as well. Electronic device 302 further includes an event interface 318 which is arranged with similar features and functionalities as the event interface 218 shown in FIG. 2.

Control signal 305 is generated by a control signal generator 323 responsively to the event detected at the event interface 318. Control signal generator 323 transmits the control signal 305 over a network interface 330 to a remote networked device. Network interface 330 is arranged with similar features and functionalities as the network interface 230 shown in FIG. 2.

The control signal generator 323 is further coupled to a user interface 345. User interface 345 is arranged to enable a user to set personalization parameters 352 that are applied to the generation of the control signal 305. Personalization parameters 352 enable the user to select and/or adjust various parameters, programming, and instructions contained in control signal 305.

By contrast to the alert signal 205 which is typically a short message, control signal 305 is generally arranged as a relatively longer message that is sent from the electronic device 302 over a network (e.g., home network 112 in FIG. 1) to other networked devices on the network. Thus, control signal 305 typically is arranged as a digital signal including multiple bytes of data that may be used to convey significantly more information about the condition or state of the electronic device 302 beyond merely a change in such state or status. The control signal 305 is alternatively implemented using one of a variety of conventional protocols including IP, SOAP, CIS, DCOM, HTTP (using XML or XHTML), RDS, SIP, SIMPLE, UPnP, or XML-RPC, for example.

In addition to acting as an indication that an event of interest has occurred, control signal 305 is selectably arranged, via personalization parameters 352, to include additional content including commands and controls that are utilizable to effectuate remote control and monitoring of one or more networked devices on the network. Thus control signal 305, in most applications of event alerting, is used to send programming instructions to the networked device, or provide more comprehensive instructions as to the implementation of a desired invoked response to the detected event. For example, when a call is received at electronic device 302, the control signal 305 is transmitted to a lighting controller (such as lighting controller 125 in FIG. 1) which instructs the lighting controller to flash lights in a particular room of the home and in a particular pattern to signal the ringing of the call.

In another example, the user-generated personalization parameters tell the control signal generator 323 to send a control signal 305 that varies according to the type of event that has occurred. Here, a first control signal is sent that programs a lighting controller to flash the lights on and off in a slow pattern, for example, when a telephone rings. A second control signal programs a lighting controller to flash the lights in a more rapid pattern if a second call comes in while a user is using the phone (i.e., a call waiting alert). And, a third control signal programs the lighting controller to use another distinctive on/off pattern to indicate that a call went unanswered but a message was left by the calling party. Similar variations of signaling can be used to uniquely identify other discrete events.

In an alternative embodiment, smart home capabilities are leveraged to further tailor the alerts and make them more effective in some circumstances. Here, all patterns of use for all the networked devices on the home network are analyzed to make predictions as to where an individual user might be located in the home. For example, during evening hours, a telephone event alert can be first sent to rooms in the home where lights are currently in use. If after several light flash cycles, the telephone is not answered, the alert can be broadcast and rendered by all devices on the network. Similarly, usage of a television or PC may be monitored. Alerts may be sent to those devices on a priority basis when the monitoring indicates that they are being used before being broadcast to other devices residing on the home network.

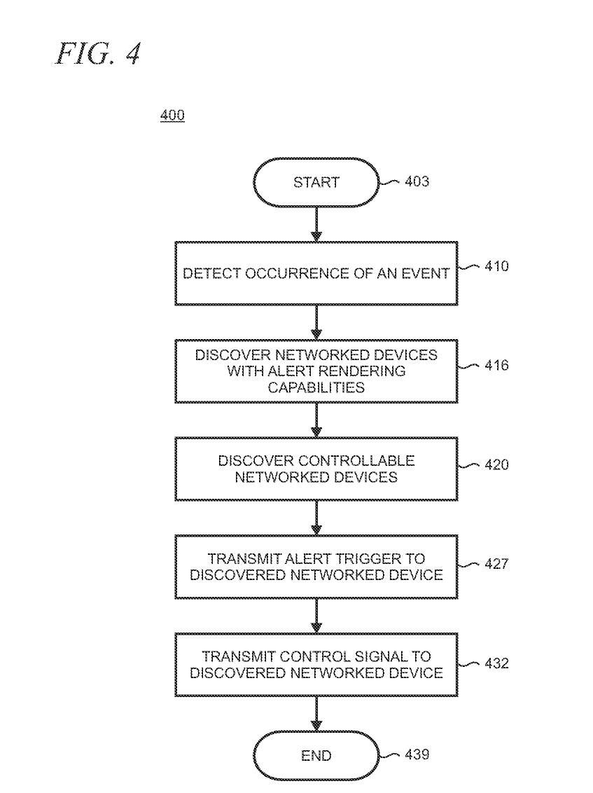

FIG. 4 is a flowchart of an illustrative method 400 performed at an electronic device having networking capabilities (such as videophone 105, electronic device 202, and electronic device 302, in FIGS. 1, 2, and 3, respectively) responsively to an event such as an incoming telephone call, e-mail, emergency alarm, scheduled appointment reminder, and the like. The illustrative method starts at block 403.

At block 410 in FIG. 4, the occurrence of an event is detected. As noted above, such detection is accomplished by monitoring one or more sensors or by direct detection as would be the case, for example, when an IP-based videophone receives an incoming video telephone call. At block 416, the electronic device discovers networked devices on a network (such as home network 112 in FIG. 1) that have the capability to render an alert from an alert trigger (e.g., alert trigger 205 in FIG. 2) and what those alert rendering capabilities include. For example, a particular network might have a lighting controller that can generate a visual alert, but no networked audio devices are present that are capable of rendering an audio alert. Such discovery can be accomplished, in one illustrative example, by command-response type interaction between the electronic device and other devices on the network using SSDP (Simple Service Discovery Protocol) services or the like.

At block 420, the electronic device discovers networked devices on the network that have the capability to receive and implement control signals (e.g., control signal 305 in FIG. 3). Some devices on the network may be remotely controlled and programmed via a control signal while others are only capable of acting in response to an alert trigger. This discovery process is similar to that described above in most applications of event alerting. As an alternative to a discovery process, the electronic device may be provided with a priori knowledge of networked devices on the network using, for example, a look up table or other database-type structure that is stored in memory (e.g. memory 130 in FIG. 1).

Responsively to the occurrence of the event at block 410, as shown in block 427, an alert trigger is sent over the network to one or more devices with alert rendering capabilities. The alert trigger is optionally personalized using personalization parameters, as described in the text accompanying FIG. 2, so that a particular device rendering the alert is selectable according to user input.

At block 432, responsively to the occurrence of the event at block 410, a control signal is sent over the network to one or more devices with control signal processing capabilities. The control signal is optionally personalized using personalization parameters, as described in the text accompanying FIG. 3, so that a particular device invoking a response to the control signal is selectable and the response itself is configurable according to user input. The illustrative method 400 ends at block 439.

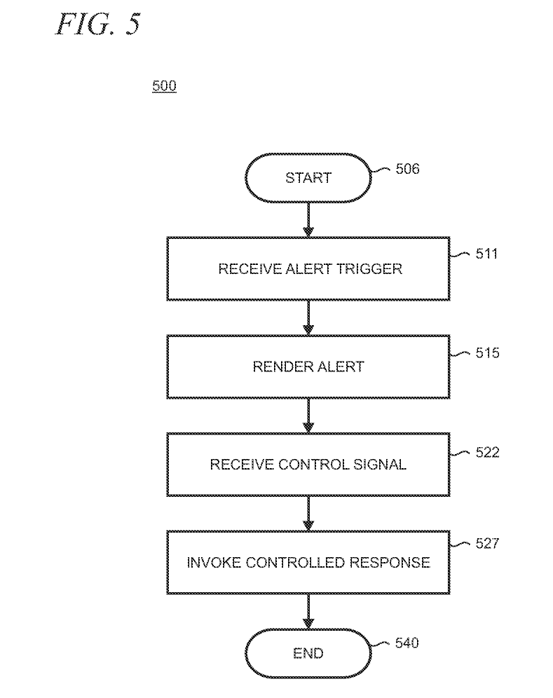

FIG. 5 is a flowchart of an illustrative method 500 performed by one or more networked devices responsively to an alert trigger 205 (FIG. 2) or a control signal 305 (FIG. 3). Examples of such a networked device include lighting controller 125, home automation controller 129, PC 133, proxy device 144 or mobile device 122 shown in FIG. 1 and described in the accompanying text. The illustrative method starts at block 506.

At block 511, a networked device receives an alert trigger (e.g., alert trigger 205 in FIG. 2) and renders the alert as indicated by block 515. As noted above, a particular network device is optionally selectable in response to user input.

At block 522, a networked device receives a control signal (e.g., control signal 305 in FIG. 3) and invokes an appropriate controlled or programmed response at block 527. Typically, a different networked device receives the control signal instead of the networked device performing the steps shown in blocks 511 and 515. This is because not all networked devices are capable of processing control signals. However, in some applications of event alerting, it may be desirable for a single device to render an alert responsively to the occurrence of one event and also invoke a programmed response responsively to the occurrence of another event. Given that the present arrangement provides for personalization to individual users, such flexibility is advantageously enabled. The illustrative method 500 ends at block 540.

Each of the processes shown in the figures and described above may be implemented in a general, multi-purpose or single purpose processor. Such a processor will execute instructions, either at the assembly, compiled, or machine-level, to perform that process. Those instructions can be written by one of ordinary skill in the art following the description contained herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A method for remotely signaling an event using an alert trigger generated by a local networked device, the method comprising:
detecting the occurrence of an event at the networked device;
locating, at the networked device, one or more remote alert rendering devices residing on a home network that are capable of rendering an alert remotely from the networked device;
responsively to the discovering, transmitting the alert trigger from the networked device over the network to the located one or more alert rendering devices so that the alert signal when received causes the alert to be rendered to thereby signal the occurrence of the event.

2. The method of claim 1 in which the event is one of incoming telephone call, incoming video telephone call, incoming e-mail, incoming video message, door bell, door knock, change in status of an IM messaging list, emergency alarm, fire alarm, smoke detector alarm, carbon monoxide alarm, burglar alarm, water level alarm, home monitoring status signaling, motion sensor alarm, appointment reminder, schedule reminder, instant message, message from an SMS service, or message from an MMS service.

3. The method of claim 1 in which the discovering or transmitting is performed using a communication protocol selected from one of IP, SOAP, CIS, DCOM, HTTP, XML, XHTML, RDS, SIP, SIMPLE, UPnP, or XML-RPC.

4. The method of claim 1 including a further step of locating, at the networked device, one or more controllable devices residing on the home network.

5. The method of claim 4 including a further step of transmitting, responsively to the discovering, a control signal to the located one or more controllable devices so that the control signal, when received, invokes a controlled action, response, or event at the one or more controllable devices.

6. The method of claim 5 in which the controlled action, response or event is one of controlling lights, generating an audio announcement or sound, or displaying a video message or image.

7. The method of claim 1 in which the locating comprises one of a) utilizing a look up table to identify one or more remote devices residing on the home network or b) utilizing a discovery process to identify one or more remote devices residing on the home network.

8. The method of claim 1 in which the alert is configured so as to signal the occurrence of the event to a hearing-impaired person or configured so as to signal the occurrence of the event to a visually-impaired person.

9. An apparatus, comprising:
a call interface arranged to detect an incoming telecommunications call;
an alert generator arranged to generate an alert when the call is received over the call interface, the alert being selectable by the alert generator from one of a plurality of configurable alert arrangements; and
a networked device interface coupled to the alert generator, the networked device interface being arranged to send the alert to a networked device over a network to thereby enable the networked device to render the alert.

10. The apparatus of claim 9 in which the apparatus is incorporated within one of videophone, mobile phone, IP-based phone, or networkable telephone.

11. The apparatus of claim 9 in which the call interface is arranged to detect an incoming call received at a remote telecommunications device to thereby enable the apparatus to function as a network proxy for the remote telecommunications device.

12. The apparatus of claim 9 in which the configurable alert is arranged to be personalized according to a user input.

13. The apparatus of claim 12 in which the personalization includes configuring an audio alert selected from one of voice, ring tone, or music or configuring a visual alert selected from one of visual pattern, visual intensity, animation, or video.

14. The apparatus of claim 12 in which the user input is indicative of a characteristic of a user, the characteristic selected from one of hearing impaired, visually impaired, user name, user age, user gender, or user's location.

15. A networking arrangement, comprising:
a network;
a plurality of network-controllable devices that are each operatively couplable to communicate over the network,
wherein at least one of the devices among the plurality is arranged for detecting an occurrence of a telephone event and transmitting a control signal to another device among the plurality so as to control the other device responsively to the telephone event occurrence.

16. The networking arrangement of claim 15 in which the network is selected from one of coaxial cable network, MoCA network, HomePlug network, HPNA network, powerline network, IP-based network, Ethernet network, wireless network including WiFi or IEEE 802.11 wireless network, or telephone network.

17. The networking arrangement of claim 15 in which the detecting device among the plurality of network-controllable devices is a videophone and the other device is a networkable lighting controller so that the control signal from the videophone initiates lighting being turned on and off to thereby render a visual signal that a call is incoming to the videophone.

18. The networking arrangement of claim 17 in which an on-off pattern of the lighting is used to communicate information about the calling party or called party or telephone event.

19. The networking arrangement of claim 15 in which the telephone event is one of incoming telephone call, call waiting, message waiting, or emergency operator interruption.

20. The networking arrangement of claim 17 in which the videophone is arranged as proxy device for a non-networked electronic device to detect an occurrence of a telephone event at the non-networked device and transmit a control signal responsively to the occurrence.
